(19) United States
(12) Patent Application Publication
(10) Pub. No.: US 2006/0043131 A1
(43) Pub. Date: Mar. 2, 2006

(54) Under-seat storage container

(76) Inventor: Steven Lee Graham, Pagosa Springs, CO (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 10/930,208

(22) Filed: Aug. 31, 2004

(51) Int. Cl. B60R 7/00

(52) U.S. Cl. 224/408; 224/275; 224/42.32

(57) ABSTRACT

A storage container for a straddle-type motor vehicle is described that comprises a top providing a seating area. A plurality of sides extend from the top and define a storage compartment. The storage compartment is longer than it is wide and oriented longitudinally along the vehicle parallel to the direction of travel. The storage container is open at the rear of the vehicle to provide access to the storage compartment without moving the seating area.

### FIELD OF THE INVENTION

The invention relates generally to the field of storage containers for motor vehicles. More particularly, the invention relates to a storage container that allows for the convenient storage and transportation of long objects on a straddle-type motor vehicle.

### BACKGROUND OF THE INVENTION

Various motor vehicles that have become particularly popular can be generally described as straddle-type motor vehicles. A straddle-type motor vehicle can be any type of motor vehicle upon which one or more riders sit by straddling a seating area. For example, typical straddle-type motor vehicles can include but are not limited to snowmobiles, motorcycles, all-terrain vehicles (ATVs), personal watercraft, etc.

A common characteristic of straddle-type motor vehicles is their relatively narrow width. This size, in part, contributes to the popularity of such vehicles since it allows the vehicles to be easily maneuvered in tight terrain. Therefore, ATVs, motorcycles, and snowmobiles are frequently used to transport people off-road into terrain that is inaccessible to other types of vehicles. For example, snowmobiles are used by skiers and snowboarders to access backcountry slopes. Similarly, ATVs are used by hunters, fishermen, campers, and others to reach secluded, roadless areas.

One drawback to straddle-type motor vehicles is the relative lack of storage space. Some straddle-type motor vehicles incorporate racks upon which cargo may be stowed for transportation. Such racks are typically mounted on the exterior of the vehicle and provide some flexibility for carrying various types of cargo. However these racks position cargo in the rider's way and affect the craft's maneuverability. For example, heavy objects placed onto such racks can significantly change the vehicles center of gravity. Further, long objects, that is, objects that are longer than the vehicle is wide, are difficult to transport on racks since it is difficult if not impossible to position the object so that it does not interfere with the vehicles maneuverability or the rider's visibility, comfort, or freedom of motion.

Other straddle-type motor vehicles incorporate interior cargo compartments such as trunks. These interior cargo compartments typically incorporate a lid for securing the cargo within the compartment. Such a compartment can be located under the seat with the seat itself serving as a lid for the compartment. While such compartments provide secure means for storing cargo within the vehicle without changing the balance or handling of the vehicle, they are typically rather small. As such they do not provide for transporting long object such as skis. Additionally, they require the user to lift or even remove the seat in order to access the compartment.

### SUMMARY OF THE INVENTION

In accordance with aspects of the present invention, the above and other problems are solved by a storage container for use in straddle-type motor vehicles as will be described below. The storage container comprises a top providing a seating area. A plurality of sides extend from the top and define a storage compartment. The storage compartment is longer than it is wide and is oriented longitudinally along the vehicle parallel to the direction of travel. The storage container is open at the rear of the vehicle to provide access to the storage compartment without moving the seating area.

In accordance with still other aspects, the present invention relates to a storage container for a straddle-type motor vehicle comprising a top providing a seating area. A plurality of sides extend from the top and define a storage compartment and a rear opening. The storage compartment is longer than it is wide and is oriented longitudinally along the vehicle parallel to the direction of travel. A retaining device is adapted to retain cargo extending from the rear opening. The retaining device comprises a first upright support adjacent to the rear opening and having a pivot, and a second upright support adjacent to the rear opening on a side opposite the first support and having a pivot. A brace is coupled with and rotatable about the pivot of the first support and the pivot of the second support.

In accordance with still other aspects, the present invention relates to a straddle-type motor vehicle comprising a flat deck coupled with a frame of the vehicle. A storage container mounted on the deck of the vehicle comprises a top providing a seating area and a plurality of sides extending from the top and defining a storage compartment below the seating area and above the deck. The storage compartment has a rear opening, is longer than it is wide, and is oriented longitudinally along the vehicle parallel to the direction of travel.

Other features of the present invention will be apparent from the accompanying drawings and from the detailed description that follows.

### BRIEF DESCRIPTION OF THE DRAWINGS

FIG. 1 is a side view of a straddle-type motor vehicle including a storage container according to one embodiment of the present invention.

FIG. 2 is a perspective view of a storage container according to one embodiment of the present invention.

FIG. 3 is a reversed perspective view of a storage container according to the embodiment illustrated in FIG. 2.

FIG. 4 is an end view of a storage container according to the embodiment illustrated in FIG. 2.

FIG. 5 is a perspective view of one embodiment of a retaining device mounting suitable for use with various embodiments of the present invention.

### DETAILED DESCRIPTION

An under-seat storage container is described for use with straddle-type motor vehicles including but not limited to snowmobiles, motorcycles, all-terrain vehicles (ATVs), personal watercraft, etc. The container defines a longitudinal, under-seat storage compartment that is oriented parallel to the direction of travel of the vehicle. Cargo can be placed into and removed from the storage compartment through an opening at the rear of the vehicle seat, without moving the seat. Further, the storage compartment, which can extend under a substantial portion or more of the seating area of the vehicle, can accept long objects such as snowboards, skis, fishing poles, firearms, surfboards, surveying equipment, etc. In this way, the overall width and center of gravity of the vehicle is not significantly affected.

As an initial matter, some terms used throughout this description are defined below.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “one variation”, “a variation” and similar phrases mean that a particular feature, structure, or characteristic described in connection with the embodiment or variation is included in at least an embodiment or variation of the invention. The phrase “in one embodiment”, “in one variation” or similar phrases as used in various places in the specification are not necessarily meant to refer to the same embodiment or the same variation.

The term “couple” or “coupled” as used in this specification and the appended claims refers to either an indirect or direct connection between the identified elements, components or objects. Often the manner of the coupling will be related specifically to the manner in which the two coupled elements interact.

The term “indicia” refers to any words, phrases, numbers, logos, pictures and/or symbols that are intended by an originator of the indicia to have meaning to a viewer thereof.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The term “cutout” as used herein refers to a hole or space in the sheet material that is substantially surrounded by remaining sheet material excepting a slot, a slit or some similar feature extending from an outside edge to the cutout. In contrast, the term “cutaway” as used herein refers to an area wherein sheet material is removed (or could have been removed) and wherein at least one outside edge of the remaining sheet material directly abuts the cutaway.

Importantly, while embodiments of the present invention will be described with reference to a snowmobile, the method and apparatus described herein are equally applicable to other types of straddle-type motor vehicles. For example, the embodiments described herein are thought to be useful in connection with motorcycles, all-terrain vehicles (ATVs), personal watercraft, etc. Additionally, the structures described below and depicted in the appended figures are offered by way of example only and are not meant to limit the scope of the invention. It is to be appreciated that numerous variations of the invention have been contemplated and would be obvious to one of ordinary skill in the art with the benefit of this disclosure

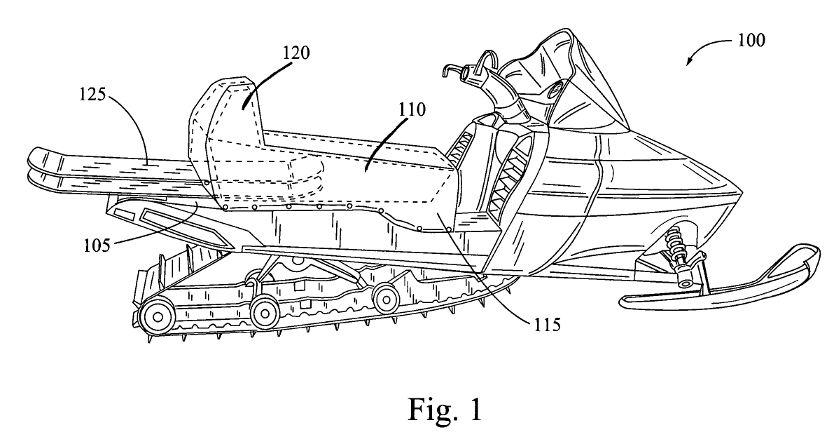

FIG. 1 is a side view of a straddle-type motor vehicle 100 including a storage container 110 according to one embodiment of the present invention. In this example, a snowmobile 100, also referred to herein as “the vehicle” 100, is illustrated as one possible straddle-type motor vehicle. The snowmobile 100, similar to many straddle-type motor vehicles, includes a flat deck 105 typically coupled with the frame of the vehicle and upon which a seat is typically mounted. In other instances, the vehicle 100 may have a tubular frame or other structure on to which a seat may be mounted. Various embodiments of the present invention are equally applicable to various types of frames or structures and will differ accordingly in their size, shape and in the way in which they attach to the vehicle.

A storage container 110 is mounted on top of the deck 105 of the vehicle 100. As will be seen below, the storage container 110 defines a storage compartment below the seating area and above the deck for containing cargo 125. The storage compartment defined by the storage container 110 is oriented parallel to the direction of travel of the vehicle 100 and extends longitudinally along the deck 105. As will be seen below, the rear of the storage container 110 may be open. Therefore, cargo 125, such as skis or snowboards as shown in this example, can be loaded from the rear of the storage compartment without moving the seat. Additionally, if the rear of the storage container 110 remains open, the overall length of the cargo 125 is not limited by the size of the storage container 110.

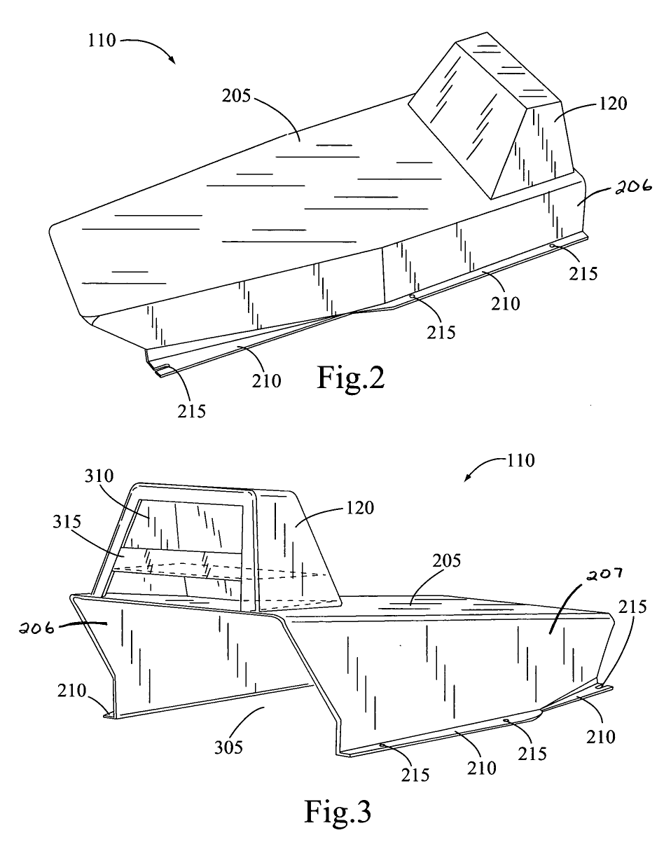

Additionally, the storage container 110 provides a seating area for the vehicle 100. Therefore the storage container 110 may be covered with a seat cushion 115 or other padded or unpadded covering. In one embodiment, the storage container 110 may also include a trunk 120 or additional storage other than the storage container 110 under the seating area of the vehicle 100. Additional details of one embodiment of this trunk will be discussed below with reference to FIGS. 2-5.

In one embodiment, the storage container 110 is made of a rigid material to provide support to the seat. For example, the storage container 110 may be constructed of sheet metal such as steel, aluminum, etc. In other cases, the storage container 110 may be made of various plastics suitable for supporting the seat. Construction methods can vary widely depending on the material used. For example, the storage container 110 may be constructed with sheets of steel and/or aluminum cut, bent, and weld to form the storage container 110. In some cases, an internal frame, within the storage container 110 may provide structural support to the seating area. However, such a frame may reduce the internal capacity of the storage container 110 and therefore may not be preferable.

The storage container 110 may be supplied as a bolt-on, after market product. In such a case, the storage container 110 may be installed by the user removing the seat, installing the storage container 110, and re-installing the seat. Alternatively, the storage container 110 may be supplied as a replacement seat including a padded or unpadded seat cover 115 over the storage container 110. In this case, the user may simply replace the factory seat with the replacement seat. In yet another case, the storage container 110 may be pre-installed on a vehicle 100 as original equipment. Additional details of storage container 110 are illustrated in FIGS. 2-5 and will be discussed below.

FIG. 2 is a perspective view of a storage container according to one embodiment of the present invention. Here the storage container 110 is shown removed from the vehicle 100 and with the seat cover 115 removed. Visible in this view is the top side 205 and the left side 206 of the storage container 110. In this example, the left side 206 extends roughly perpendicular from the top side 205 of the storage container 110. Also, the top side 205 and left side 206 are shaped to conform to the structure of the vehicle to which it will be mounted and to provide a seating area for one or more riders. Therefore, the exact size and shape of the storage container 110 may vary significantly depending on the vehicle to which it will be mounted. However, the storage container 110 is preferably longer than it is wide to facilitate the storage of long objects, i.e., objects that are longer than the width of the seating area of the vehicle. For example, a storage compartment 110 that is substantially longer than it is wide, within the confines of the vehicle, is more suitable for carrying very long objects such as skis.

Also visible in FIG. 2 is a mounting bracket 210 extending along the bottom edge of the left side 206 of the storage container 110. The mounting bracket 210 my include a number of mounting holes 215 for accepting bolts or screws for otherwise attaching the storage container 110 to the deck 115 or frame of the vehicle 100. Of course, depending upon the vehicle 100 upon which the storage container 110 is mounted, the shape size, location, and even presence of the mounting bracket and mounting holes, if any, may vary significantly. For example, in some cases the mounting bracket 210 or other part of the storage container 110 may be welded, rather than bolted or screwed, to the deck 105 or frame of the vehicle 100. In other cases, the side of the storage container 110 may include holes for mounting bolts or screws.

The storage container 110 may be formed from sheet metal by bending or stamping a single sheet of metal or may be constructed of several sheets cut to size and welded together. Alternatively, the storage container 110 may be constructed of other types of materials and by other methods. For example, the storage container 110 may be constructed of plastic formed by injection molding or other process. As noted above, an internal frame (not shown here) may be included to provide structural support to the seating area. However, such a frame may reduce the internal capacity of the storage container 110 and therefore may not be preferable.

Also shown in the example illustrated in FIG. 2 is an optional trunk 120 mounted on top of the top side 205 of the storage container 110. The trunk 120 may be constructed as an integral part of the storage container 110. For example, the trunk 120 and storage container 110 may be molded as a single unit or structure. In other cases, the trunk 120 may be constructed separate from the storage container 110 and welded, bolted, screwed, or otherwise affixed to the storage container 110. In another embodiment, the trunk 120 may be removeably attached to the storage container 110 via tabs and slots, hooks, screws, bolts, or other means.

As illustrated in FIGS. 1 through 5, the trunk 120 may shaped, sized, and positioned to provide a backrest for the seating area of the vehicle 100 when the storage container 110 is installed on the vehicle 100. Alternatively, the trunk 120, if any, may be positioned differently. For example, one or more trunks may be located on the right side 207 or left side 206 of the storage container 110.

FIG. 3 is a reversed perspective view of a storage container according to the embodiment illustrated in FIG. 2. Visible in this view is the top side 205, the left side 206, and the right side 207 of the container. In this example, the left side 206 and right side 207 extend roughly perpendicular from the top side 205 of the storage container 110. Also, the top side 205, left side 206, and right side 207 are shaped to conform to the structure of the vehicle to which the storage container 110 is mounted and to provide a seating area for one or more riders. Therefore, the exact size and shape of the storage container 110 may vary significantly depending on the vehicle on which it is mounted.

Also visible in this view is a mounting bracket 210 extending along the bottom edge of the left side 206 and right side 207 of the storage container 110. The mounting bracket 210 my include a number of mounting holes 215 for accepting bolts or screws for attaching the storage container 110 to the deck 115 or frame of the vehicle 100. Of course, depending upon the vehicle 100 upon which the storage container 110 is mounted, the shape size, and location of the mounting bracket 210 and mounting holes 215, if any, may vary significantly. For example, in some cases the mounting bracket 210 or other part of the storage container 110 may be welded, rather than bolted or screwed, to the deck 105 or frame of the vehicle 100. In other cases, the side of the storage container 110 may include holes for mounting bolts or screws.

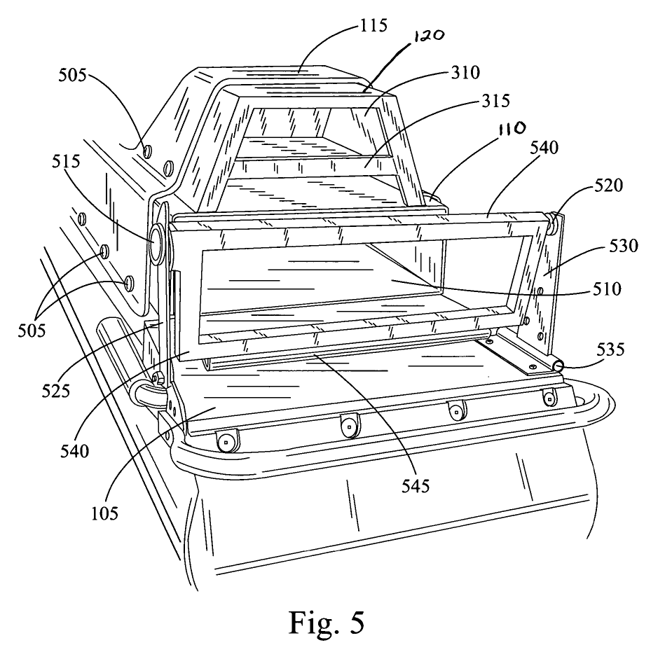

The top side 205, right side 207, and left side 206 of the storage container 110 define a storage compartment 305 into which cargo may be placed when the storage container 110 is mounted on the vehicle 100. In the embodiment illustrated in FIG. 3, the bottom of the storage compartment 305 is open. In such a case, the deck 115 of the vehicle 100, as illustrated in FIG. 1, serves as the bottom of the storage compartment 315 when the storage container 110 is mounted on the vehicle 100. In other embodiments, the storage container 110 may include a bottom 510 as shown in FIG. 5 that, together with the top side 205, right side 207, and left side 206 encompass and enclose the storage compartment 305.

As noted above, the exact size and shape of the storage container 110 may vary significantly depending on the vehicle to which it is mounted. However, the storage container 110 is preferably longer than it is wide, as illustrated here, to facilitate the storage of long objects, i.e., objects that are longer than the width of the seating area of the vehicle. For example, a storage compartment 110 that is substantially longer than it is wide, within the confines of the vehicle, is more suitable for carrying very long objects such as skis.

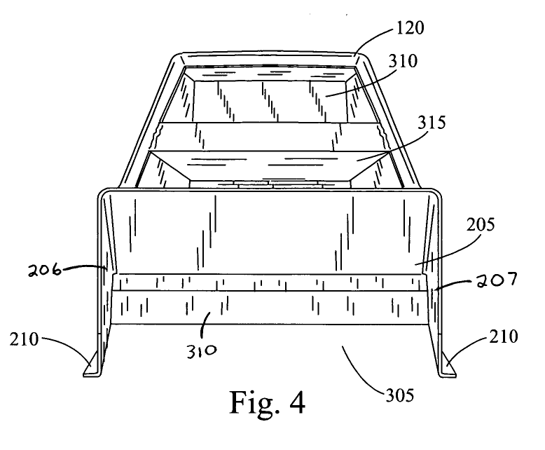

The front of the storage container 110 may be open, closed, or, as illustrated in FIG. 4, partially open and shaped to engage a portion of the vehicle 100, such as the fuel tank, to enclose the front of the storage compartment 305 when the storage container 110 is mounted on the vehicle 100. Preferably, the rear of the storage container 110 may remain open as illustrated here to allow quick, easy access to the storage compartment 305. Additionally, if the rear of the storage container 110 remains open, the overall length of the cargo is not limited. Therefore, extremely long cargo may be stored in the storage container 110 and extend out from the back of the vehicle 100. In this way, extremely long cargo can be easily transported without significantly changing the handling of the vehicle 100. Alternatively, the rear of the storage container 110 may include a door or other cover to enclose and secure the storage compartment 305.

In some cases, various mounting accessories (not shown here) such as inserts, dividers, drawers, fasteners, latches, hooks, etc. may be included in the storage compartment 305 to accommodate different cargo for different applications. For example, mounting accessories for ski area medical kits, division of wildlife/veterinary equipment, search and rescue tools, land surveying equipment, ice fishing gear, etc. may be mounted in different locations within the storage compartment 305.

Also shown in the example illustrated in FIGS. 2 and 3 is an optional trunk 120 mounted on the top side 205 of the storage container 110. The trunk 120 may be constructed as an integral part of the storage container 110. For example, the trunk 120 and storage container 110 may be molded as a single unit or structure. In other cases, the trunk may be constructed separate from the storage compartment and welded, bolted, screwed, or otherwise affixed to the storage compartment. In another embodiment, the trunk may be removeably attached to the storage compartment via tabs and slots, bolts, or other means.

As illustrated in FIGS. 1 through 5, the trunk 120 may shaped, sized, and positioned to provide a backrest for the seating area of the vehicle 100 when the storage container 110 is installed on the vehicle 100. Alternatively, the trunk, if any, may be positioned differently. For example, one or more trunks may be located on the right side or left side of the storage compartment.

As shown in FIG. 3, the trunk 120 defines a trunk compartment 310 suitable for storing cargo. In one embodiment, the trunk compartment 310 may contain one or more shelves 315. The shelf 315 and trunk 120 may be molded as a single unit or structure. In other cases, the shelf 315 may be constructed separate from the trunk 120 and welded, bolted, screwed, or otherwise affixed to the trunk 120. In another embodiment, the shelf 315 may be removeably attached to the trunk 120 via tabs and slots, hooks, bolts, screws, or other means.

FIG. 4 is an end view of a storage container according to the embodiment illustrated in FIG. 2. This view illustrates the storage container 110 with an optional trunk 120 attached. Visible in this example is the trunk compartment 310 and self 315 within the trunk 120. Also visible here is the top side 205, right side 207, and left side 206 of the storage container 110. As discussed above, the top side 205, right side 207, and left side 206 of the storage container 110 define a storage compartment 305. Also visible in this view is the front end 310 of the storage container. In this example, the front end 310 of the storage container 110 partially encloses the storage compartment 305 and is shaped to mate with the vehicle 100 on which the storage container 110 is mounted to completely enclose the front of the storage compartment 305. For example, if the storage container 110 in mounted on a snowmobile as shown in FIG. 1, the front end 310, top side 205, right side 207, and left side 206 of the storage container 110 may be configured to mate with deck 105 the frame, gas tank, and other structures of the vehicle 100 to enclose the storage compartment 305.

According to an alternative embodiment of the present invention, the storage container left side 206 and right side 207 may additionally define a hollow chamber on each side of the storage compartment 305. Thus, the sides and top may form a catamaran-like structure including the hollow chambers on either side. The chambers may be used for auxiliary or main fuel storage. For example, the storage container 110 and fuel tank of the vehicle may be constructed as a single unit with the hollow chamber on either side of the storage compartment 305 providing fuel storage.

FIG. 5 is a perspective view of an embodiment of a retaining device suitable for use with various embodiments of the present invention. This view illustrates a storage container 110 mounted on the deck 105 of a straddle-type motor vehicle. In this example, the storage container 110 includes a bottom side 510 to enclose the storage compartment rather than relying on the deck 105 of the vehicle to close the bottom of the storage compartment. According to one embodiment of the present invention, the bottom side 510 as well as the sides and top of the storage container 110 may be covered with a non-slip material or padding to help retain and/or protect cargo within the storage compartment. As illustrated in FIG. 5, the bottom side 510 does not extend beyond the storage container 110. However, in some embodiments, the bottom side 510 may extend along the deck 105, beyond the end of the storage container 110. In some cases, the bottom side 510 may even extend beyond the end of the deck 105 or the vehicle itself to provide support for very long items placed in the storage compartment. In one embodiment, the bottom side 510 of the storage container 110 may comprise an extension that is slideable into and out of the storage container to provide support for long items as needed.

Also shown in FIG. 5 is an optional trunk 120 similar to that discussed above with reference to FIGS. 2-4 mounted on top of the storage container 110. The trunk 120 in this example defines a trunk compartment 310 in which is mounted an optional shelf 315. The trunk 120 and storage container 110 are covered with a seat cover 115 which may or may not be padded. The seat cover 115 may be fastened to the trunk 120, the storage container 110, and/or the vehicle via one or more seat cover fasteners 505. The seat cover fasteners 505 may comprise a wide variety of removable fasteners including but not limited to snaps, buttons, Velcro, bolts, screws, etc. Alternatively, the seat cover 115 may be affixed to the trunk 120, the storage container 110, and/or the vehicle by an adhesive, stitching, or other more permanent means.

Also shown in this view is one embodiment of a retaining device 500 for securing cargo within the storage compartment. In this embodiment, the retaining device 500 comprises a plurality of upright supports 525 and 530 including a left support 525 and a right support 520 mounted on the deck 105 of the vehicle. One or both of the supports 525 and 530 may be mounted on the deck 105 of the vehicle via a support hinge 535.

Disposed between the supports 525 and 530 is a brace 540. The brace 540 may be connected with the supports 525 and 530 via one or more pivots 515 and 520. The pivots 515 and 520 may comprise a bolt or other fastener passing through the supports 525 and 530 and into the brace 540. In such a case, the brace 540 may be removed, disconnect, or freed from one or more of the supports 525 or 530. For example, a bolt used to provide the right pivot 520 may be removed to allow the right support 530 to swing away from the brace on support hinge 535.

Bolts or other fasteners used as pivots 515 and 520 may also be loosened to allow brace 540 to swing upwards, away from the storage container 110 and deck 105 of the vehicle to provide access to the storage compartment. For example, a bolt though pivot 520 may be loosened and brace 540 rotated upwards to allow cargo such a snowboard to be slid into the storage compartment. The brace 540 of the retaining device 500 may then be rotated back to clamp the cargo to the deck 105 of the vehicle or bottom side 510 of the storage compartment 110. The bolt at pivot 520 may then be tightened to secure the cargo in place. Since the brace may be rotated around pivots 515 and 520 and then secured at different positions throughout its travel, the grip range, i.e., the height of the cargo, can be variable. That is, the position of the brace 540 when pivots 515 and 520 are secured can vary from a minimum point to a maximum point along an arch of motion of the bottom of the brace 540. Since the brace 540 retains the cargo by directly contacting the portion that extends into the retaining device 500, the brace 540 may also include padding 545 such as foam rubber or other cushioning material.

Alternatively, other types of retaining devices are easily contemplated. For example, rather than the brace 540 being rotatable about pivots 515 and 520, the brace may be slidablely coupled with the supports 525 and 530 so that the brace may slide up and down to clamp cargo of various heights extending from the storage compartment. In another case, a bungee cord (not shown here) may be connected to the storage container 110 and/or the vehicle to strap the cargo to the deck 105 of the vehicle or to the storage container 110. In another embodiment, a net, gate, or door may be fastened to the storage container 110 and/or the vehicle.

The various preferred embodiments and variations thereof illustrated in the accompanying figures and/or described above are merely exemplary and are not meant to limit the scope of the invention. It is to be appreciated that numerous variations of the invention have been contemplated and would be obvious to one of ordinary skill in the art with the benefit of this disclosure. All variations of the storage container that read upon the appended claims are intended and contemplated to be within the scope of the invention.

What is claimed is:

1. A storage container for a straddle-type motor vehicle comprising:
a top providing a seating area; and
a plurality of sides extending from the top and defining a storage compartment, the storage compartment being longer than it is wide and oriented longitudinally along the vehicle parallel to the direction of travel wherein the storage container is open at the rear of the vehicle to provide access to the storage compartment without moving the seating area.

2. The storage container of claim 1, further comprising a mounting bracket extending from at least one of the sides and adapted to secure the storage container to the vehicle.

3. The storage container of claim 2, wherein the mounting bracket defines a plurality of mounting holes adapted to accept fasteners to secure the storage container to the vehicle.

4. The storage container of claim 1, further comprising a bottom disposed between the plurality of sides to enclose the storage compartment.

5. The storage container of claim 4, wherein the bottom is covered with a non-slip material.

6. The storage container of claim 1, wherein the storage container is covered with a seat covering.

7. The storage container of claim 6, wherein the storage container is mounted to a deck of the vehicle.

8. The storage container of claim 7, wherein the vehicle comprises a snowmobile.

9. The storage container of claim 1, further comprising a trunk mounted on the top of the storage container to provide a backrest for the seating area and defining a trunk compartment.

10. The storage container of claim 9, wherein the trunk compartment includes at least one shelf.

11. A storage container for a straddle-type motor vehicle comprising:
a top providing a seating area;
a plurality of sides extending from the top and defining a storage compartment and a rear opening, the storage compartment being longer than it is wide and oriented longitudinally along the vehicle parallel to the direction of travel; and
a retaining device adapted to retain cargo extending from the rear opening, the retaining device comprising a first upright support adjacent to the rear opening and having a pivot, and a second upright support adjacent to the rear opening on a side opposite the first support and having a pivot, and a brace coupled with and rotatable about the pivot of the first support and the pivot of the second support.

12. The storage container of claim 11, wherein the retaining device is mounted on a deck of the vehicle.

13. The storage container of claim 11, wherein the retaining device is mounted on the storage container.

14. The storage container of claim 12, wherein the pivot of the first support comprises a bolt passing through the first support.

15. The storage container of claim 14, further comprising a hinge disposed between and coupled with the deck of the vehicle and the first support wherein the first support is rotatable about the hinge when the bolt is removed from the first support.

16. The storage container of claim 11, wherein the brace is adapted to retain cargo in the storage compartment be pressing long items extending from the storage compartment against the deck of the vehicle.

17. The storage container of claim 11, further comprising a bottom disposed between the plurality of sides to enclose the storage compartment.

18. The storage container of claim 17, wherein the brace is adapted to retain cargo in the storage compartment be pressing long items extending from the storage compartment against the bottom of the storage container.

19. The storage container of claim 11, further comprising a mounting bracket extending from at least one of the sides and adapted to secure the storage container to the vehicle, wherein the mounting bracket defines a plurality of mounting holes adapted to accept fasteners to secure the storage container to the vehicle.

20. The storage container of claim 11, wherein the vehicle is a snowmobile.

21. A straddle-type motor vehicle comprising:
a flat deck coupled with a frame of the vehicle; and
a storage container mounted on the deck of the vehicle comprising a top providing a seating area and a plurality of sides extending from the top and defining a storage compartment below the seating area and above the deck, the storage compartment having a rear opening, the storage compartment being longer than it is wide and oriented longitudinally along the vehicle parallel to the direction of travel.

22. The vehicle of claim 21, further comprising a retaining device mounted on the deck and adapted to retain cargo extending from the rear opening of the storage container, the retaining device comprising a first upright support adjacent to the rear opening and having a pivot, and a second upright support adjacent to the rear opening on a side opposite the first support and having a pivot, and a brace coupled with and rotatable about the pivot of the first support and the pivot of the second support.

23. The vehicle of claim 21, further comprising a mounting bracket extending from at least one of the sides and adapted to secure the storage container to the vehicle.

24. The vehicle of claim 23, wherein the mounting bracket defines a plurality of mounting holes adapted to accept fasteners to secure the storage container to the vehicle.

25. The vehicle of claim 21, further comprising a bottom disposed between the plurality of sides to enclose the storage compartment.

26. The vehicle of claim 21, wherein the pivot of the first support of the retaining device comprises a bolt passing through the first support.

27. The vehicle of claim 26, further comprising a hinge disposed between and coupled with the deck of the vehicle and the first support wherein the first support is rotatable about the hinge when the bolt is removed from the first support.

28. The vehicle of claim 21, wherein the brace of the retaining device is adapted to retain cargo in the storage compartment be pressing long items extending from the storage compartment against the deck of the vehicle.

29. The storage container of claim 25, wherein the brace is adapted to retain cargo in the storage compartment be pressing long items extending from the storage compartment against the bottom of the storage container.

30. The vehicle of claim 21, wherein the vehicle is a snowmobile.
